(19) United States
(12) Patent Application Publication
(10) Pub. No.: US 2004/0062511 A1
(43) Pub. Date: Apr. 1, 2004

(54) Variable optical attenuator

(76) Inventors: Paul Blair, Edinburg (GB); Jean Podlecki, Edinburg (GB)

Correspondence Address: SUGHRUE MION, PLLC, 2100 PENNSYLVANIA AVENUE, N.W., SUITE 800, WASHINGTON, DC, 20037, US

(21) Appl. No.: 10/467,377

(22) PCT Filed: Feb. 7, 2002
(86) PCT No.: PCT/GB02/00534

(30) Foreign Application Priority Data
Feb. 8, 2001 (GB) 0103124.4

(51) Int. Cl. G02B 6/26

(52) U.S. Cl. 385/140; 385/25

(57) ABSTRACT

A variable optical attenuator comprising a lightguide defining an optical path, the lightguide being divided into first (1) and second parts (2) separated by a gap (3) which crosses the optical path; an optically transparent actuator (7) adapted to be displaced within the gap along a path inclined to the optical path to attenuate a light beam passing along the optical path; the actuator having front (8) and rear (9) faces, at least a portion of the rear face (9) being inclined to the optical path such that the light beam incident on the rear face is substantially totally internally reflected by the rear face within the actuator.

The present invention relates to a variable optical attenuator, in particular a micro electromechanical variable optical attenuator. More particularly, but not exclusively, the present invention relates to a variable optical attenuator including an actuator which attenuates light by total internal reflection.

Micro electromechanical variable optical attenuators typically comprise an actuator having an optically reflective coating. The actuator is adapted to be displaced into an optical beam in order to attenuate the beam.

The application of the optically reflective coating to the actuator is technically challenging for a number of reasons

(a) the actuator is often relatively inaccessible within the device;

(b) the requirement for vertical uniform side wall coating of the actuator; and,

(c) the limitations of evaporation and sputtering technology currently available.

As a result of these difficulties and limitations the optically reflective coating is not applied uniformly to the actuator. Other parts of the device also tend to be coated during the coating process.

A non uniform coating of the actuator is detrimental to the role of the device as a variable optical attenuator. The reflection coefficient of the part of the actuator which interacts with the beam will not be constant. In addition the non uniform coating introduces both polarisation and wavelength dependent loss in light incident on the actuator.

The coating of other parts of the device in addition to the actuator is also undesirable as the actuator tends to adhere to such other parts of the device. Extensive precautions must be taken to prevent this.

It is an object of the present invention to provide a variable optical attenuator which does not require the application of an optically reflective coating.

Accordingly, in a first aspect of the invention there is provided a variable optical attenuator comprising

a lightguide defining an optical path, the lightguide being divided into first and second parts separated by a gap which crosses the optical path;

an optically transparent actuator adapted to be displaced within the gap along a path inclined to the optical path to attenuate a light beam passing along the optical path;

the actuator having front and rear faces, at least a portion of the rear face being inclined to the optical path such that the light beam incident on the rear face is substantially totally internally reflected by the rear face within the actuator.

The variable optical attenuator according to the invention does not require an optically reflective coating. This simplifies the manufacturing process. It also reduces the unwanted phase and wavelength dependent loss of the actuator.

The rear face can be planar. Alternatively, the rear face can be curved. Such geometries are relatively simple to manufacture.

At least a portion of the front face can be inclined to the optical path. This ensures that light which is reflected from this portion of the front face does not pass back along the lightguide.

The front face can be planar. This is relatively simple to manufacture. Alternatively, the front face can be curved, preferably convex. A curved front face can be used to direct light reflected from the front face to a specific focus or area, for example away from adjacent devices.

The actuator can be wedge shaped in a plane parallel to the optical path, such that the front and rear faces meet to define an edge. The reduction of the thickness of the actuator proximate to the edge also reduces the phase and wavelength dependent loss of the attenuator.

The actuator preferably further comprises a further optical lightguide adapted to receive the light totally internally reflected within the actuator.

In a further aspect of the invention there is provided an optically transparent actuator for attenuating a light beam, the actuator comprising front and rear faces;

the actuator being wedge shaped in a plane normal to the front and rear faces such that the front and rear faces meet to define an edge.

The present invention will now be described by way of example only and not in any limitative sense with reference to the accompanying drawings in which:

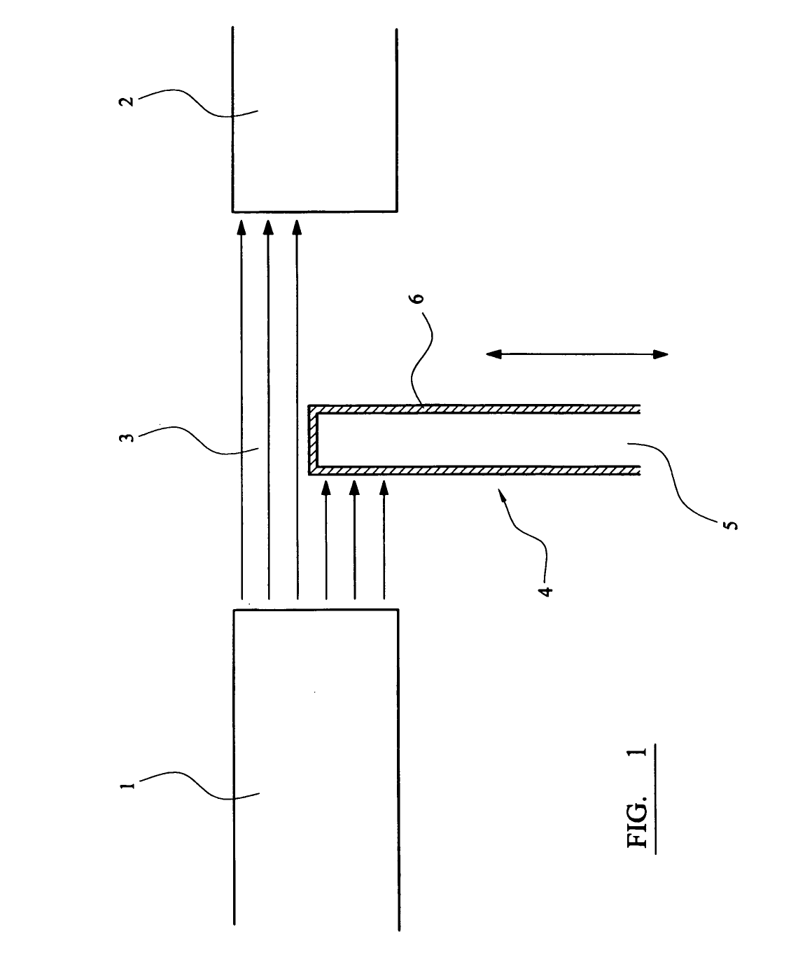

FIG. 1 shows a known variable optical attenuator;

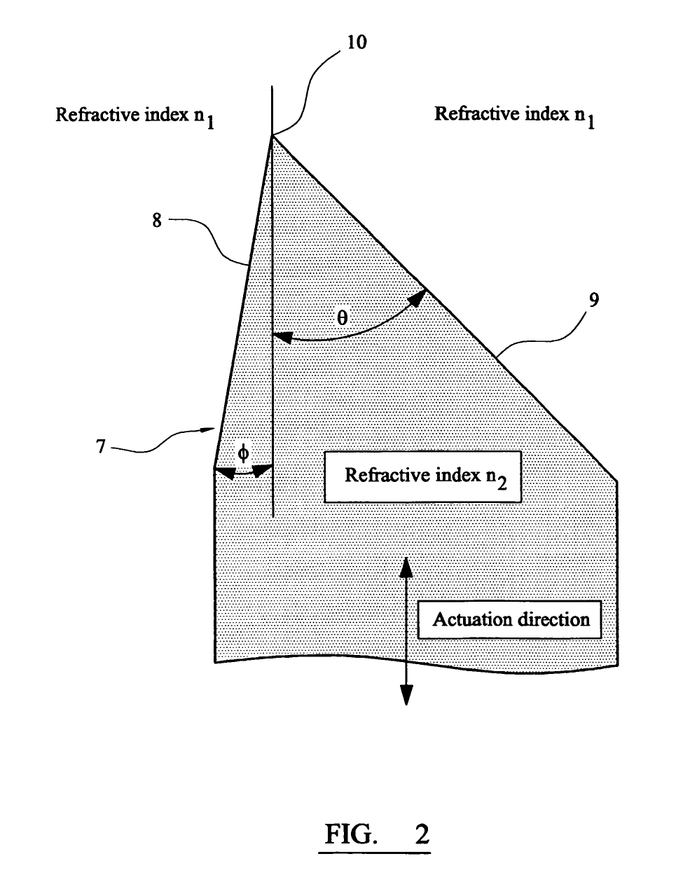

FIG. 2 shows an actuator of a variable optical attenuator according to the invention in cross section;

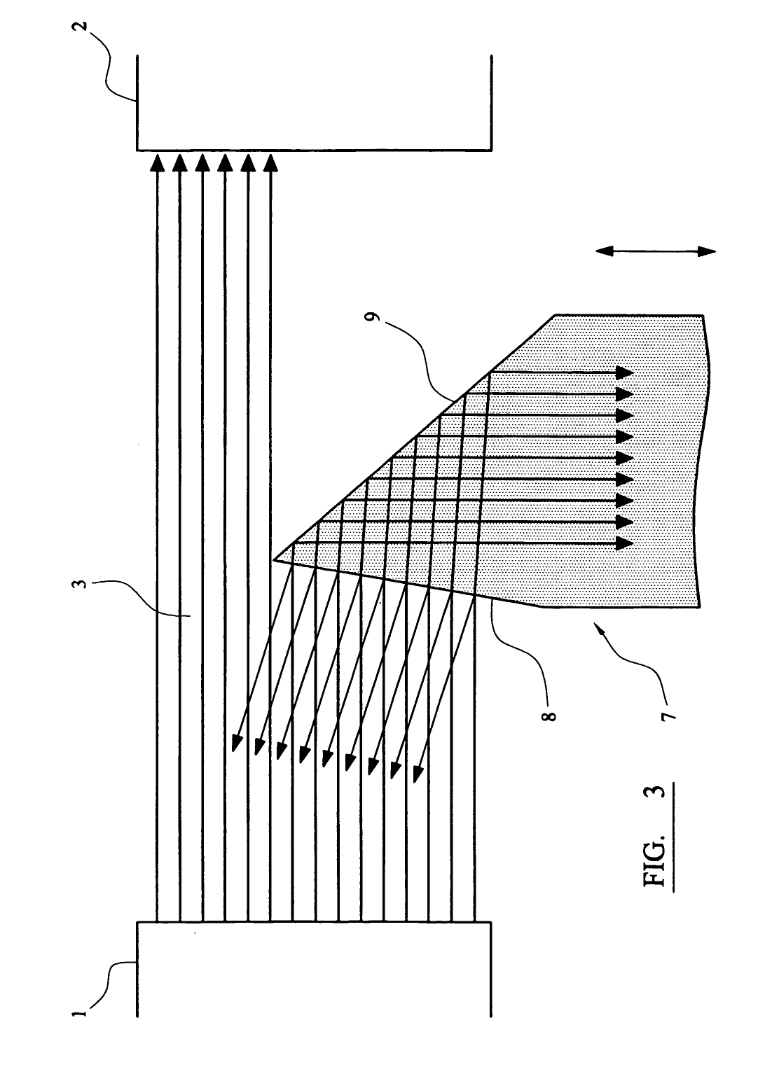

FIG. 3 shows a variable optical attenuator according to the invention including the optical actuator of FIG. 2;

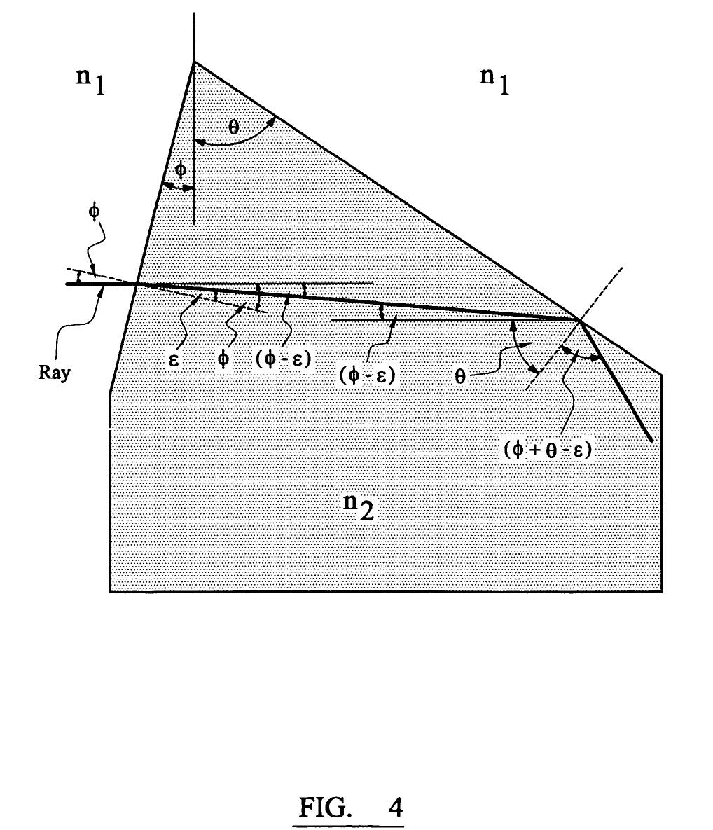

FIG. 4 shows the path of a light ray refracted by the actuator of FIG. 3; and,

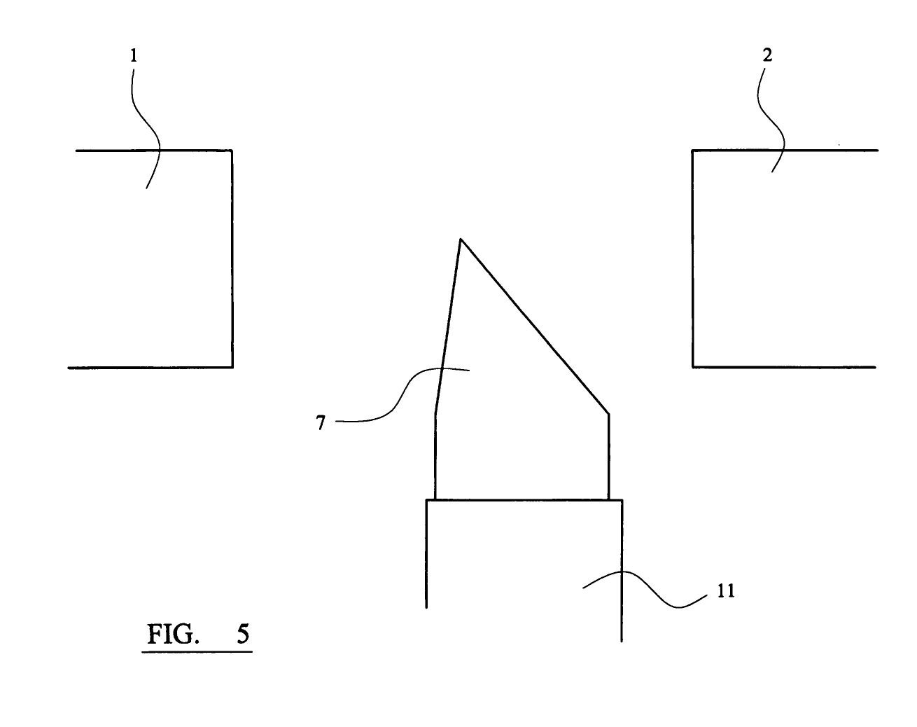

FIG. 5 shows a second embodiment of a variable optical attenuator according to the invention.

Shown in FIG. 1 is a known variable optical attenuator. The attenuator comprises first and second optical lightguides (1,2) which define an optical path. The lightguides (1,2) are separated to form a gap (3) which crosses the optical path. An actuator (4) can be displaced within the gap by a displacement means (not shown) to attenuate an optical beam crossing the gap (3) between the first and second lightguides (1,2).

The actuator (4) comprises a support (5) coated in an optically reflective layer (6) such as gold. The application of the optically reflective layer (6) to the actuator (4) can be technically difficult as the actuator (4) can be relatively inaccessible. An attenuator including such an actuator (4) can suffer polarisation dependent loss due to both non uniformities in the thickness of the reflective layer (6) and also the finite thickness of the portion of the actuator (4) which interacts with the beam.

Shown in FIG. 2 is an actuator (7) of a variable optical attenuator according to the invention. The actuator (7) is made from an optically transparent material. The actuator comprises front and rear planar faces (8,9). As can be seen, the actuator (7) is generally wedge shaped in cross section with the front and rear faces (8,9) meeting at an edge (10). By ensuring the front and rear faces (8,9) meet at an edge (10) the polarisation dependent loss induced by use of the actuator (7) within the variable optical attenuator is reduced. In contrast, in the prior art device of FIG. 1 the thickness of the attenuator inherently gives rise to polarisation dependent loss. An ideal attenuator would have zero thickness so as not to cause any polarisation dependent loss.

FIG. 3 shows in cross section a variable optical attenuator according to the invention including the actuator (7) of FIG. 2. The attenuator comprises first and second lightguides (1,2) which define an optical path. The lightguides (1,2) are separated to define a gap (3) which crosses the optical path. The gap (3) is filled with an optically transparent medium of refractive index (1). The medium is typically air of refractive index η₁ The actuator (7) is connected to a displacement means (not shown) enabling it to be displaced within the gap (3) in a plane normal to the optical path.

When the actuator (7) is fully removed from the gap (3) light can travel from the first to the second lightguides (1,2) across the gap (3) with minimal attenuation.

If the actuator (7) is displaced into the gap (3) then a portion of the light travelling across the gap (3) will be incident on the actuator front face (8). The optically transparent material of the actuator is of a refractive index (η₂) higher than that of the surrounding material. This results in a portion of this light being reflected from the front face (8). However, as the front face (8) is inclined to the normal to the optical path this reflected light will be reflected away from the optical path and will not return along the lightguide (1). The refractive index of the actuator material is typically larger than 1.4.

A portion of the light incident on the front face of the actuator will be transmitted into the actuator. The path of this light is shown in greater detail in FIG. 4. The light is refracted at the front face by an angle ε due to the differing refractive indices of the surrounding medium and the actuator. The angle ε is measured with respect to the normal to the front face and is given by

ε=sin⁻¹[η₁ sin φ/Θ₂]

The light then travels across the actuator to the rear face where it is totally internally reflected. To ensure total internal reflection at the rear face the incident angle of the light with respect to the normal of the rear surface must be greater than a critical angle α such that

ø+θ−ε>∝

where α is given by

∝=sin⁻¹ (η₁/η₂)

φ and θ are the angles of the first and second surfaces to a plane normal to the optical path in the surrounding medium respectively, as shown in FIG. 4. For a silicon actuator the minimum angle θ for a range of φ values is given in table 1.

As the actuator (7) is displaced further within the gap (3) a greater proportion of the light traversing the gap (3) between the first and second lightguides (1,2) is incident on the actuator (7) and reflected out of the optical path. Hence, by movement of the actuator (7) one can control the attenuation of the light traversing the gap (3) between first and second lightguides (1,2).

Shown in FIG. 5 is a further embodiment of a variable optical attenuator according to the invention. The optical attenuator includes a further lightguide (11) adapted to receive the light totally internally reflected within the actuator (7). Such an attenuator may act as a switch. By displacing the actuator (7) into the light beam traversing the gap one may divert or switch the light reflected within the actuator (7) towards the third lightguide (11) rather than the second (2).

The intensity of the light reflected towards the third lightguide (11) can be measured by a sensor (not shown). The output of the sensor can be used in a feedback loop to control the attenuation provided by the attenuator.

In a further aspect of the invention the rear face of the actuator is curved, rather than planar. Only the portion of the second face which is inclined to the optical path at an angle greater than the brewster angle will totally internally reflect the incident light beam.

In the above embodiments of the invention the actuator is displaced in a plane normal to the optical path. In a further embodiment of the invention the actuator is adapted to be displaced on a path inclined to the normal to the optical path.

In a further embodiment of the invention the actuator is in the form of a truncated wedge whereby the front and rear faces do not meet to form an edge but are separated by an edge face.

In a further embodiment of the invention the front face of the actuator is curved. This shape of front face can be designed to direct light reflected from this face in a predetermined direction, for example away from sensitive nearby apparatus.

1. A variable optical attenuator comprising
a lightguide defining an optical path, the lightguide being divided into first and second parts separated by a gap which crosses the optical path;
an optically transparent actuator adapted to be displaced within the gap along a path inclined to the optical path to attenuate a light beam passing along the optical path;
the actuator having front and rear faces, at least a portion of the rear face being inclined to the optical path such that the light beam incident on the rear face is substantially totally internally reflected by the rear face within the actuator.

2. A variable optical attenuator as claimed in claim 1, wherein the rear face is planar.

3. A variable optical attenuator as claimed in claim 1, wherein the rear face is curved.

4. A variable optical attenuator as claimed in any one of claims 1 to 3, wherein at least a portion of the front face is inclined to the optical path.

5. A variable optical attenuator as claimed in claim 4, wherein the front face is planar.

6. A variable optical attenuator as claimed in claim 4, wherein the front face is curved, preferably convex.

7. A variable optical attenuator as claimed in any one of claims 1 to 6, wherein the actuator is wedge shaped in a plane parallel to the optical path, such that the front and rear faces meet to define an edge.

8. A variable optical attenuator as claimed in any one of claims 1 to 7 comprising a further optical lightguide adapted to receive the light totally internally reflected within the actuator.

9. An optically transparent actuator for attenuating a light beam, the actuator comprising of front and rear faces;
the actuator being wedge shaped in a plane normal to the front and rear faces such that the front and rear faces meet to define an edge.

10. A variable optical attenuator substantially as hereinbefore described.

11. A variable optical attenuator substantially as hereinbefore described with reference to the drawings.
